(19) United States
(12) Patent Application Publication
(10) Pub. No.: US 2012/0130864 A1
(43) Pub. Date: May 24, 2012

(54) SYSTEMS AND METHODS TO ANALYZE A SELLER INVENTORY OFFERED FOR SALE ON A NETWORK-BASED MARKETPLACE

(75) Inventors: Auston McReynolds, San Jose, CA (US); Joren Bartley McReynolds, Mountain View, CA (US)

(73) Assignee: eBay Inc., San Jose, CA (US)

(21) Appl. No.: 12/950,056

(22) Filed: Nov. 19, 2010

(51) Int. Cl. G06Q 30/00

(52) U.S. Cl. 705/27.2

(57) ABSTRACT

Systems and methods to analyze a seller inventory on a network-based marketplace 76 are disclosed. The system receives identify information, over a network, from a client machine, the identify information identifies a seller that is registered to sell on a network-based marketplace. The system further receives a request for an analysis of items being offered for sale by the seller on the network-based marketplace. The request includes a category identifier that is utilized to identify the first plurality of items. The system analyzes the items listings to generate report information including item information describing the items and communicates a user interface, over a network, to the client machine.

### TECHNICAL FIELD

This disclosure relates to the technical field of data communications and, more particularly, to systems and methods to analyze a seller inventory being electronically offered for sale on a network-based marketplace.

### RELATED ART

Sellers who offer their merchandise for sale on a network-based marketplace may compete with other sellers. In some instances two items may directly compete particularly where the two offerings are the same product. One seller may compete with each other by lowering their price or by changing the presentation of their item to effect the presentation of the rank of the item in search results.

### BRIEF DESCRIPTION OF THE DRAWINGS

Embodiments illustrated by way of example and not limitation in the figures of the accompanying drawings, in which:

FIG. 1 is a block diagram illustrating a system to analyze a seller inventory being electronically offered for sale, according to an embodiment;

FIG. 2 is a block diagram illustrating a system, according to an embodiment, to execute the methods described herein;

FIG. 3 is a block diagram illustrating marketplace modules and payment modules, according to an embodiment;

FIG. 4A is a block diagram illustrating listing management modules, according to an embodiment;

FIG. 4B is a block diagram illustrating public services modules, according to an embodiment;

FIG. 5A is a block diagram illustrating tables, according to an embodiment;

FIG. 5B is a block diagram illustrating a user table, according to an embodiment;

FIG. 5C is a block diagram illustrating an items table, according to an embodiment;

FIG. 6A is a block diagram illustrating an item listing, according to an embodiment;

FIG. 6B is a block diagram illustrating user information, according to an embodiment;

FIG. 7 is a block diagram illustrating category data structure, according to an embodiment;

FIG. 8 is a block diagram illustrating a method, to analyze a seller inventory offered for sale on a network-based marketplace, according to an embodiment;

FIG. 9 is a flow chart illustrating a method, according to an embodiment, to identify seller inventory offered on for sale on a network-based marketplace;

FIGS. 10-13B are illustrations of user interfaces, according to an embodiment; and

FIG. 14 shows a diagrammatic representation of a machine in the example form of a computer system, according to an example embodiment.

### DETAILED DESCRIPTION

In the following description, for purposes of explanation, numerous specific details are set forth in order to provide a thorough understanding of some example embodiments. It will be evident, however, to one of ordinary skill in the art that embodiments of the present disclosure may be practiced without these specific details.

As described further below, according to various example embodiments of the disclosed subject matter described and claimed herein, systems and methods to analyze a seller inventory offered for sale on a network-based marketplace are described. Various embodiments are described below in connection with the figures provided herein.

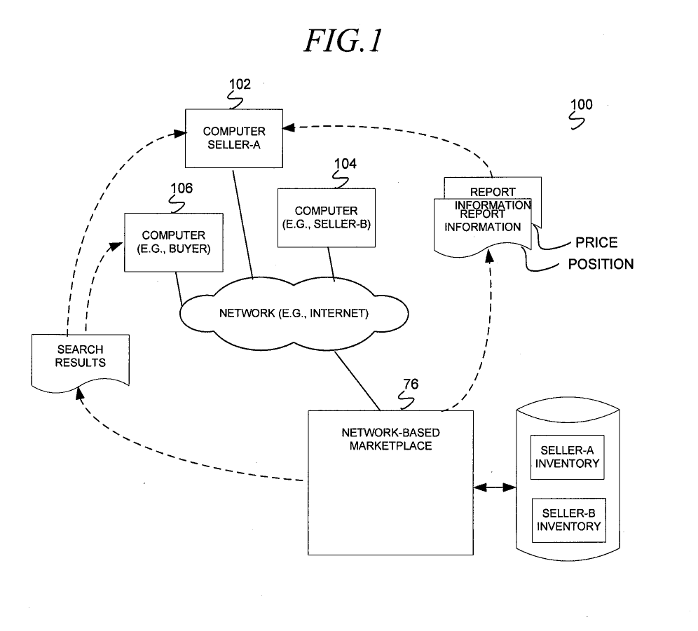

FIG. 1 is a block diagram illustrating a system 100, according to an embodiment, to analyze a seller inventory on a network-based marketplace 76. The network-based marketplace 76 is shown to be connected with computers 102, 104, and 106 over a network (e,g., Internet) The computers 102, 104 may be respectively be operated by “seller-A” and “seller-B” who enter item listings on the network-based marketplace 76 and a buyer who browses the item listings to acquire by purchase or bid one or more items featured in the item listings.

In some instances the seller-A and seller-B may be directly competing with one another by offering items that are the same product. In some instances, a competitive advantage may be achieved by one seller over the other seller by lowering their price and/or by improving the position or rank of the item listing in search results. For example, a buyer who is operating the computer 106 may enter a search query that is communicated to and received by the network-based marketplace 76 that, in turn, responds to the query by generating and communicating search results to the computer 106 that include all links to items item listings matching the query “IPOD Nano.” The search results may include links to item listings that are offered for sale by both the seller-A and seller-B. The position or rank of the item listings in search may be determined by an algorithm (e.g., “best match”) based on multiple factors some of which may be altered, modified, or changed by the seller. Accordingly, one seller may alter the information that is included item listing to improve the position of the item listing in the search results. For example, item listings that are presented on the first page of search results may have a greater likelihood of purchase than item listings that are presented on the fifth page of search results.

According to the present disclosure, systems and methods to analyze a seller inventory are described. According to one embodiment, a network-based marketplace may receive identify information, over a network, from a client machine. For example, the identify information may identify a seller that is registered to sell items (e.g., goods or services) on a network-based marketplace 76. The identify information may include a user name and a password that identifies the seller. The network-based marketplace 76 may further receive from the seller a request to perform an analysis of items currently being offered for sale by the seller on the network-based marketplace 76. That is, the seller may request an analysis of their entire inventory currently being offered or an identified part of the inventory. In some instances, the request may include a category identifier that is utilized to identify a part of the entire inventory. In response to receiving the request, the network-based marketplace 76 may analyze the identified item listings to generate report information including item information describing the items and to communicate a user interface, over a network, to the client machine that includes the report information. The seller may request report information that is organized according to price or report information that is organized according to the position or rank of the seller's inventory in search results. The seller may utilize the report information that is organized according to price to competitively re-price all or part of their inventory. The seller may further utilize the report information that is organized according to position to modify their item listings to effectively improve the position or rank of all or part of their inventory in search results. The embodiment may be described in greater detail and operate as follows for an example embodiment.

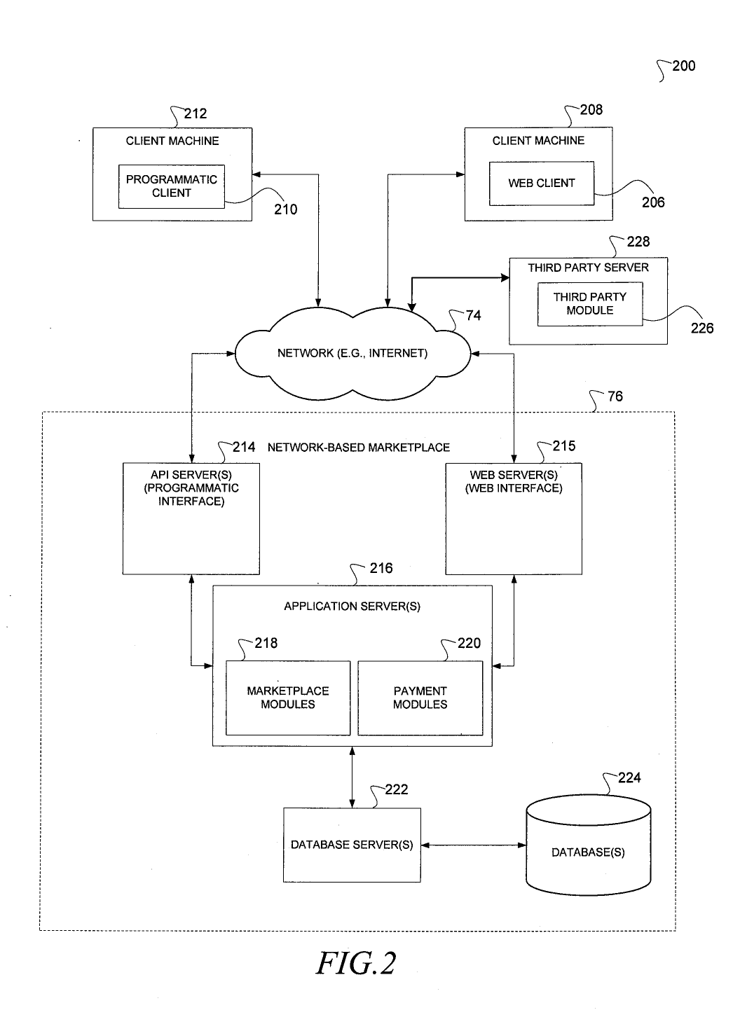

FIG. 2 is a network diagram depicting a networked system 200, within which one example embodiment may be deployed. A network-based marketplace 76 provides server-side functionality, via a network 74 (e.g., the Internet or Wide Area Network (WAN)) to one or more clients. FIG. 2 illustrates, for example, a web client 206 (e.g., a browser, such as the Internet Explorer browser developed by Microsoft Corporation of Redmond, Wash.) executing on a client machine 208 and a programmatic client 210 executing on client machine 212.

An application program interface (API) server 214 and a web server 215 are coupled to, and provide programmatic and web interfaces respectively to, one or more application servers 216. The application servers 216 host one or more marketplace modules 218 and payment modules 220. The application servers 216 are, in turn, shown to be coupled to one or more database servers 222 that facilitate access to one or more databases 224.

The marketplace modules 218 may provide a number of marketplace functions and services to users that access the network-based marketplace 76. The payment modules 220 may likewise provide a number of payment services and functions to users. The payment modules 220 may allow users to accumulate value in accounts and then to later redeem the accumulated value for products (e.g., goods or services) that are made available via the marketplace modules 218. Value may be accumulated in a commercial currency, such as the U.S. dollar, or a proprietary currency, such as “points.” While the marketplace modules 218 and payment modules 220 are shown in FIG. 2 to both form part of the network-based marketplace 76, it will be appreciated that, in alternative embodiments, the payment modules 220 may form part of a payment service that is separate and distinct from the network-based marketplace 76.

Further, while the networked system 200 shown in FIG. 2 employs a client-server architecture, embodiments of the present disclosure are, of course, not limited to such an architecture and could equally well find application in a distributed, or peer-to-peer, architecture system, for example. The various marketplace modules 218 and payment modules 220 could also be implemented as standalone software programs, which do not necessarily have networking capabilities.

The web client 206 and mobile programmatic client 210 access the various marketplace modules 218 and payment modules 220 via the web interface supported by the web server 215. Similarly, the programmatic client 210 accesses the various services and functions provided by the marketplace modules 218 and payment modules 220 via the programmatic interface provided by the API server 214. The programmatic client 210 may, for example, be a seller module (e.g., the TurboLister application developed by eBay Inc., of San Jose, Calif.) to enable sellers to author and manage listings on the network-based marketplace 76 in an off-line manner, and to perform batch-mode communications between the programmatic client 210 and the network-based marketplace 76.

FIG. 2 also illustrates a third party module 226, executing on a third party server machine 228, as having programmatic access to the networked system 200 via the programmatic interface provided by the API server 214. For example, the third party module 226 may, utilizing information retrieved from the network-based marketplace 76, support one or more features or functions on a website hosted by the third party. The third party website may, for example, provide one or more promotional, marketplace or payment functions that are supported by the relevant modules of the networked system 200.

### Marketplace and Payment Modules

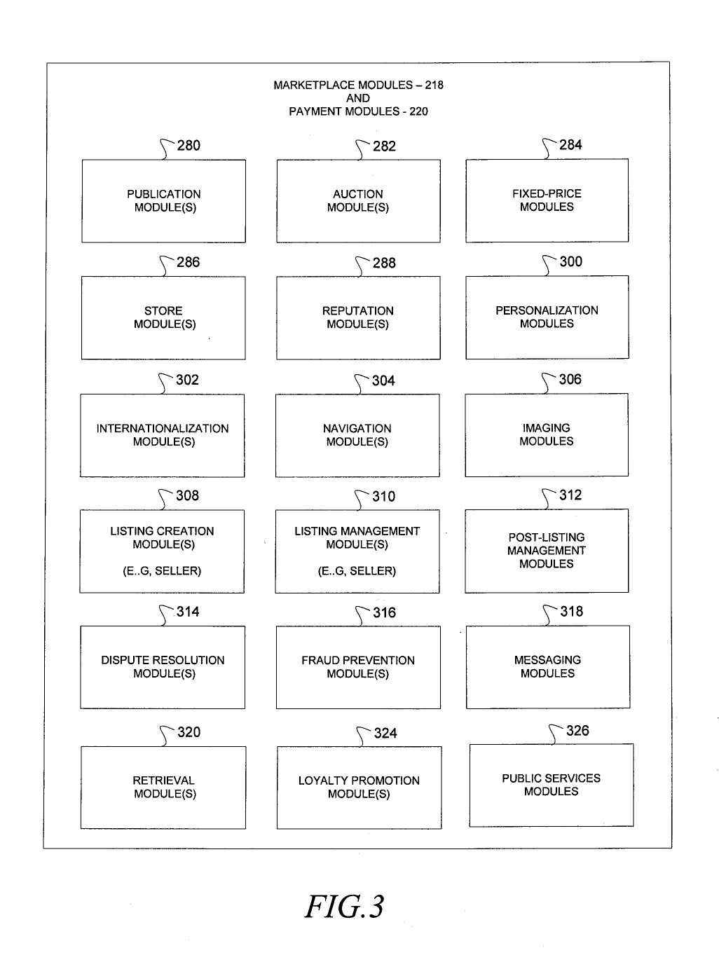

FIG. 3 is a block diagram illustrating marketplace modules 218 and payment modules 220 (e.g., software applications) that, in one example embodiment, are provided as part of the networked system 200 of FIG. 2. The marketplace modules 218 and payment modules 220 may be hosted on dedicated or shared server machines, as shown in FIG. 2, that are communicatively coupled to enable communications between server machines. The modules themselves are communicatively coupled (e.g., via appropriate interfaces) to each other and to various data sources, so as to allow information to be passed between the modules or so as to allow the modules to share and access common data. The modules may furthermore access one or more databases 224 via the database servers 222, as shown in FIG. 2.

The network-based marketplace 76 may provide a number of publishing, listing and price-setting mechanisms whereby a seller may list (or publish information concerning) goods or services for sale; a buyer can express interest in or indicate a desire to purchase such goods or services; and a price can be set for a transaction pertaining to the goods or services. To this end, the marketplace and payment modules 218 and 220 are shown to include at least one publication module 280 and one or more auction modules 282 that support auction-format listing and price setting mechanisms (e.g., English, Dutch, Vickrey, Chinese, Double, Reverse auctions, etc.). For example, the publication module(s) 280 may include a publishing module 281 (not shown) that may be utilized to store a listing in a database and publish the listing on the network-based marketplace. The various auction modules 282 may also provide a number of features in support of such auction-format listings, such as a reserve price feature whereby a seller may specify a reserve price in connection with a listing, and a proxy-bidding feature whereby a bidder may invoke automated proxy bidding.

A number of fixed-price modules 284 may support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings and may allow a buyer to purchase goods or services, which are also being offered for sale via an auction, for a fixed-price that is typically higher than the starting price of the auction.

Store modules(s) 286 may allow a seller to group listings within a “virtual” store, which may be branded and otherwise personalized by and for the seller. Such a virtual store may also offer promotions, incentives and features that are specific and personalized to a relevant seller.

Reputation module(s) 288 may allow users that transact, utilizing the network-based marketplace 76, to establish, build and maintain reputations, which may be made available and published to potential trading partners. Consider, for example, that where the network-based marketplace 76 supports person-to-person trading, users may otherwise have no history or other reference information whereby the trustworthiness and credibility of potential trading partners may be assessed. The reputation module(s) 288 allow a user to establish a reputation within the network-based marketplace 76 over time, for example, through feedback provided by other transaction partners. Other potential trading partners may then reference such a reputation for the purposes of assessing credibility and trustworthiness.

Personalization modules 300 may allow users of the network-based marketplace 76 to personalize various aspects of their interactions with the network-based marketplace 76. For example a user may, utilizing appropriate personalization modules 300, create a personalized reference page at which information regarding transactions to which the user is (or has been) a party may be viewed. Further, the personalization modules 300 may enable a user to personalize listings and other aspects of their interactions with the networked system 200 and other parties.

The networked system 200 may support a number of marketplaces that are customized, for example, for specific geographic regions. A version of the networked system 200 may be customized for the United Kingdom, whereas another version of the networked system 200 may be customized for the United States. Some of these versions may operate as an independent marketplace, or may be customized (or internationalized) presentations of a common underlying marketplace. The networked system 200 may accordingly include a number of internationalization modules 302 that customize information (and/or the presentation of information) by the networked system 200 according to predetermined criteria (e.g., geographic, demographic or marketplace criteria). For example, the internationalization modules 302 may be used to support the customization of information for a number of regional websites that are operated by the networked system 200.

Navigation of the network-based marketplace 76 may be facilitated by one or more navigation modules 304. For example, browse modules may allow users to browse various category, catalogue, or inventory data structures according to which listings may be classified within the networked system 200. Various other navigation modules 304 may be provided to supplement the search and browsing modules.

In order to make listings available via the networked system 200 as visually informing and attractive as possible, the marketplace and payment modules 218 and 220 may include one or more imaging modules 306 with which users may upload images for inclusion within listings. The imaging modules 306 may also operate to incorporate images within viewed listings. The imaging modules 306 may also support one or more promotional features, such as image galleries that are presented to potential buyers. For example, sellers may pay an additional fee to have an image included within a gallery of images for promoted items.

Listing creation modules 308 may allow sellers to conveniently author listings of items (e.g., parts) pertaining to goods or services that they wish to transact via the network-based marketplace 76. For example, the listing creation modules 308 may enable sellers to identify their items as products. Also for example, the listing creation modules 380 may include a receiving module for receiving unstructured information in the form of item information (e.g., string) and a processing module that may parse the unstructured information to generate structured information that is stored by the publishing module 281 in a listing. The listing management modules 310 may allow sellers to manage such listings. Specifically, where a particular seller has authored and/or published a large number of listings, the management of such listings may present a challenge. The listing management modules 310 may provide a number of features (e.g., auto-relisting, inventory level monitors, etc.) to assist the seller in managing such listings. For example, the listing management modules 310 may be utilized by a seller to analyze an inventory of items that are listed for auction or sale on the networked-based marketplace 76. The report information that is generated from such an analysis may be utilized to more competitively price, items or to improve the rank of the item listings in search results.

One or more post-listing management modules 312 may also assist sellers with a number of activities that may typically occur post-listing. For example, upon completion of an auction facilitated by one or more auction module(s) 282, a seller may wish to leave feedback regarding a particular buyer. To this end, the post-listing management modules 312 may provide an interface to one or more reputation module(s) 288, so as to allow the seller to conveniently provide feedback regarding multiple buyers to the reputation module(s) 288.

Dispute resolution modules 314 may provide mechanisms whereby disputes arising between transacting parties may be resolved. For example, the dispute resolution modules 314 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention modules 316 may implement fraud detection and prevention mechanisms to reduce the occurrence of fraud within the network-based marketplace 76.

Messaging modules 318 may be responsible for the generation and delivery of messages to users of the network-based marketplace 76, with such messages, for example, advising users regarding the status of listings at the network-based marketplace 76 (e.g., providing “outbid” notices to bidders during an auction process or providing promotional and merchandising information to users). Respective messaging modules 318 may utilize any one of a number of message delivery networks and platforms to deliver messages to users. For example, messaging modules 318 may deliver electronic mail (e-mail), instant message (IM), Short Message Service (SMS), text, facsimile, or voice (e.g., Voice over IP (VoIP)) messages via the wired network (e.g., the Internet), Plain Old Telephone Service (POTS), or wireless (e.g., mobile, cellular, WiFi (e.g., IEEE 802.11 technologies including 802.11n, 802.11b, 802.11g, and 802.11a)), and Worldwide Interoperability for Microwave Access (e.g., WiMAX-IEEE 802.16) networks.

Retrieval modules 320 may support various searching functions that are made available to buyers to enable buyers to find listings. For example, the retrieval modules 320 may include a retrieving module 329 that receives a query from a buyer to identify listings. The network-based marketplace 76 itself, or one or more parties that transact via the network-based marketplace 76, may operate loyalty programs that are supported by one or more loyalty promotions modules 324. For example, a buyer may earn loyalty or promotions points for transactions established and/or concluded with a particular seller, and may then be offered a reward for which accumulated loyalty points can be redeemed. The public services modules 326 may be utilized by the public or any other entity to access trading, finding and best match services.

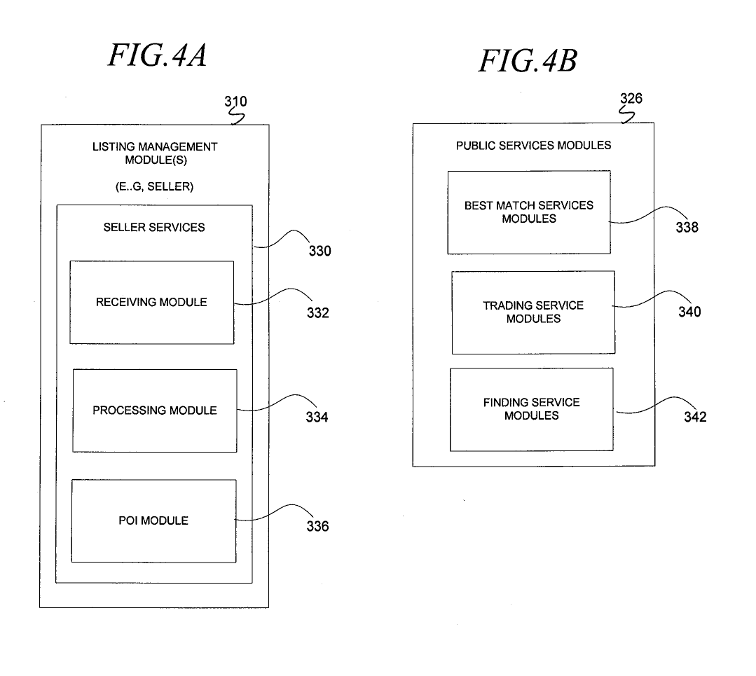

FIG. 4A is a block diagram illustrating listing management modules 310, according to an embodiment, to provide seller services 330. The seller services 330 may include a receiving module 332, a processing module 334 and a POI module 336. The receiving module 332 may be used to receive identity information that describes a user. For example, the identity information may include a user identifier in the form of an email address, identity number, or some other identifier that uniquely distinguishes the user from other users on the network-based marketplace 76. The processing module 334 may be used to receive a request for an analysis of items being offered for sale by a user (e.g., seller) and to communicate a user interface that includes report information that provides such an analysis. In some embodiments, the request may include a category identifier that is utilized to identify a subset of all of the items offered for sale on the network-based marketplace 76. For example, the category identifier may identify a category that may include other categories that collectively include items that may be analyzed to generate report information. The POI (Poor Obfuscation Implementation) module 336 may be used to generate report information in various Microsoft Office file formats, such as Word®, PowerPoint® and Excel®. Components for the POI module 336 may be obtained from Apache POI, a project run the Apache Software Foundation.

FIG. 4B is a block diagram illustrating public services modules 326, according to an embodiment. The public services modules 326 may include a best match service module 338, a trading service module 340, and a finding service module 342. The best match service module 342 may be utilized to retrieve information about a product, seller identifiers that identify sellers and item listings that are being offered for sale by the sellers according to product. The phrase “best match” may identify an algorithm that ranks the presentation of item listings in search results that are returned responsive to a search query. For example, the “best match” algorithm may utilize multiple factors sometimes numbering in the hundreds to rank a particular item listing. Accordingly, the best match services modules 326 may further retrieve the rank or position of an item listing in search results. The trading service modules 340 and the finding service modules 342 may be used accessed to retrieve item information for items.

### Data Structures

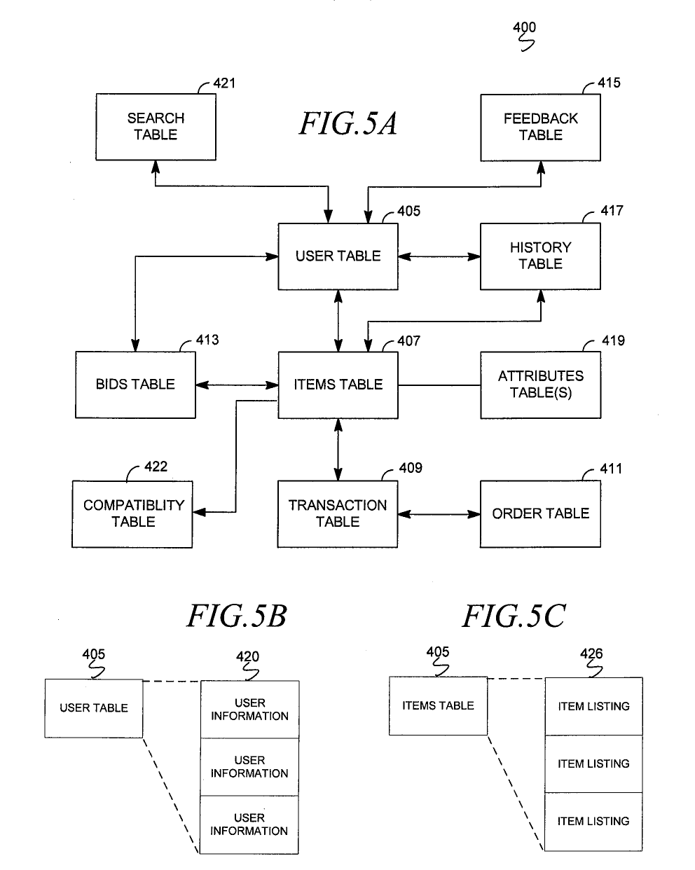

FIG. 5A is a high-level entity-relationship diagram illustrating various tables 400 that may be maintained within the databases 224, and that are utilized by and support the marketplace modules 218 and payment modules 220. A user table 405 contains a record for registered users of the network-based marketplace 76. A user may operate as a seller, a buyer, or both, within the network-based marketplace 76. In one example embodiment, a buyer may be a user that has accumulated value (e.g., commercial or proprietary currency), and is accordingly able to exchange the accumulated value for items that are offered for sale by the network-based marketplace 76.

The tables 400 also include an items table 407 in which item records are maintained for goods (e.g., parts) and services that are available to be, or have been, transacted via the network-based marketplace 76. Item records (e.g., item listings) within the items table 407 may furthermore be linked to one or more user records within the user table 405, so as to associate a seller and one or more actual or potential buyers with an item record.

A transaction table 409 contains a record for each transaction (e.g., a purchase or sale transaction) pertaining to items for which records exist within the items table 407.

An order table 411 may be populated with order records, with each order record being associated with an order. Each order, in turn, may be associated with one or more transactions for which records exist within the transaction table 409.

Bid records within a bids table 413 may relate to a bid received at the network-based marketplace 76 in connection with an auction-format listing. A feedback table 415 may be utilized by one or more reputation modules 288, in one example embodiment, to construct and maintain reputation information concerning users. A history table 417 may be used to maintain a history of transactions to which a user has been a party. One or more attributes tables 419 record attribute information pertaining to items for which records exist within the items table 407. Considering only a single example of such an attribute, the attributes tables 419 may indicate a currency attribute associated with a particular item, with the currency attribute identifying the currency of a price for the relevant item as specified by a seller. A search table 421 may store search information that has been entered by a user (e.g., buyer) who is looking for a specific type of listing.

A compatibility table 322 may store catalogue information according to an embodiment.

FIG. 5B is a block diagram illustrating a user table 405, according to an embodiment. The user table 405 is shown to include user information 420 for each user that has registered on the network-based marketplace 76. A particular user may function as a buyer, seller, or in some other capacity.

FIG. 5C is a block diagram illustrating an items table 407, according to an embodiment. The items table 407 may include an item listing 426 that describes one or more items that are being offered for sale on the network-based marketplace 76. Each item listing 426 may be associated with a seller and may further be utilized to offer one or more items of the same product for sale on the network-based marketplace 76

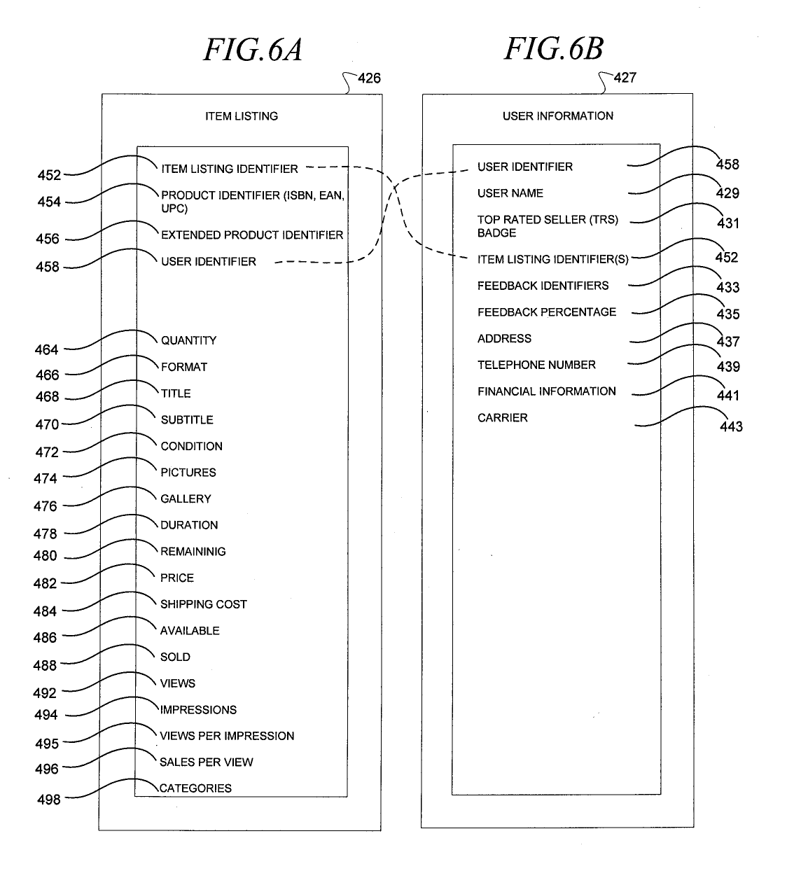

FIG. 6A is a block diagram illustrating an item listing 426, according to an embodiment. The item listing 426 may be utilized to store information for one or more items that are being offered for sale on the network-based marketplace 76. The item listing 426 may include an item identifier 452, a product identifier 454, and an extended product identifier 454. The item identifier 452 may be utilized to uniquely identify the item on the network-based marketplace 76. The product identifier 454 may be used to uniquely identify the product for which the item is an instance. For example, the product identifier 454 may be embodied as an International Standard Book Number (ISBN), a European Article Number (EAN) or a Universal Product Code. The extended product identifier 454 may uniquely identify a product within the network-based marketplace 76. The item listing 426 is further shown to include a user identifier 458 that identifies the user (e.g., seller) that is offering the item described by the item listing for sale on the network-based marketplace 76. A quantity 464 may describe the number of items for auction or sale. A format 466 may be used to store the sales format including an auction, buy it now (BIN), or some other type of format or combination of formats. The title 468 and subtitle 470 may store the user provided titles for the item listing 426. The condition 472 may store the condition of the item (e.g., BRAND NEW, LIKE NEW, etc.). The pictures 474 entry may store one or more pictures and the gallery 476 may store a specialized type of picture presentation. The duration 478 may store the duration of time, as configured by the seller, the item may be offered in an auction and the remaining 480 entry may store amount of time remaining in the auction. The item listing is further shown to include a price 482, a shipping cost 484 and an available 486 entry that stores the number of items that continue to be available for sale. The sold 488 may store the number of items that have been sold. The views 492 entry may store the number of search results in which the item listing has been presented. For example, a views 492 entry of “five” may indicate a link to the item listing 426 has appeared in “five” different search results that have been respectively displayed in response to five queries. The impressions 494 entry may store the number of times the link to the item listing 426 was selected from the search results. The views per impressions 495 may store a ratio computed by dividing the views 492 by the impressions 494. The sales per view 496 may store a ratio computed by dividing the sold 488 with views 492. The categories 498 field may store one or more categories included in hierarchy of categories (e.g., category data structure) in which the item listing 426 has been categorized.

FIG. 6B is a block diagram illustrating user information 427, according to an embodiment. The user information 427 may be utilized to store information for a particular user (e.g., seller, buyer, etc.). The user information 427 may include a user identifier 458, a user name 429 and a top rated seller (TRS) status 431 (e.g. ON/OFF) that may be awarded to sellers that reach or exceed predetermined seller criteria (e.g., minimum sales volume, minimum revenue, etc.). The user information 427 may further include one or more item identifiers 452 that may be utilized to uniquely identify item listings 426 on the network-based marketplace 76 that are being offered for sale by the user. The user information 427 may further include feedback identifiers 462, feedback percentage 435, an address 437, financial information 441, and a carrier. The feedback identifier 433 may be utilized to identify and count the number of feedbacks associated with the user. For example, the feedback may be stored in the feedback table 415, as shown on FIG. 5A and store comments or remarks left by other users on the network-based marketplace 76 about the performance of the user in different transactions. The feedback percentage 435 may store the ratio of positive to total feedback associated with the user, for example where feedback may be identified as positive, neutral or negative. The carrier 443 may identify a shipping carrier that is utilized by the seller to ship items that have been auctioned or sold by the seller.

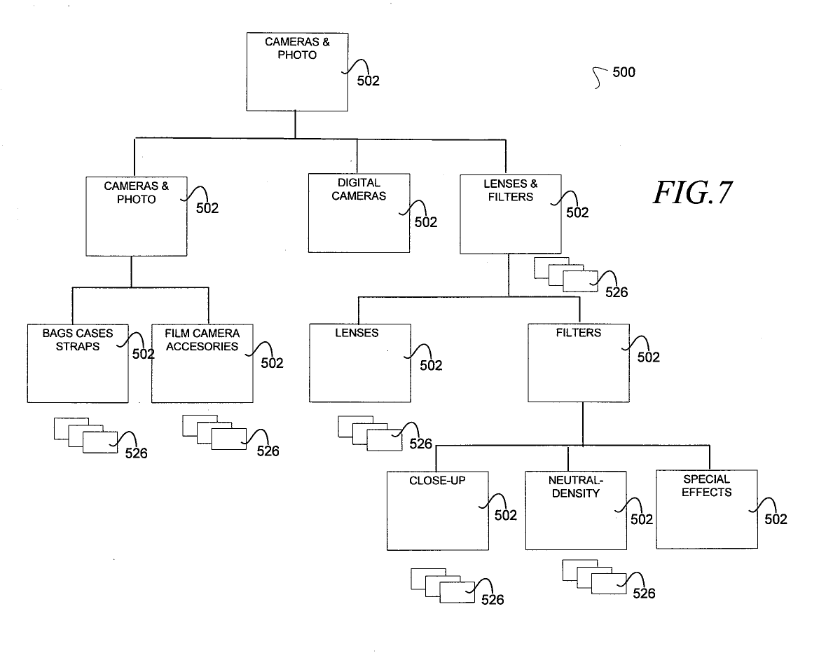

FIG. 7 is a block diagram illustrating category data structure 500 (e.g., category data structure), according to an embodiment. The category data structure 500 may include categories 502 that may include other categories 502 and/or store item listings 526 that may be browsed by a user. According to one embodiment, a seller may identify all or a portion of their inventory for sale by identifying a particular category 502. For example, an identification of the “LENSES & FILTERS” category may identify the item listings 526 that are stored under the “LENSES & FILTERS” category, the “LENSES” category, the “FILTERS” category, the “CLOSE-UP” category, and the “NEUTRAL DENSITY” category. Conversely, the same identification of the “LENSES & FILTERS” category excludes the item listings 526 that are stored under the “BAGS CAES STRAPS” category and the “FILM CAMERA ACCESORIES” category.

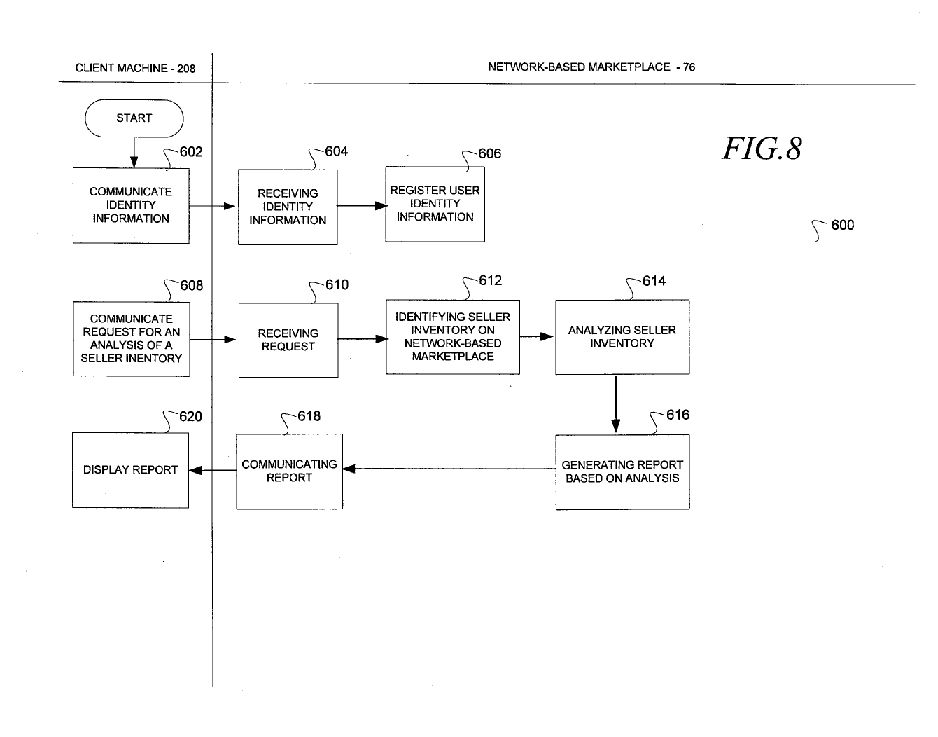

FIG. 8 is a block diagram illustrating a method 600, to analyze a seller inventory being electronically offered for sale on a network-based marketplace 76, according to an embodiment. Illustrated on the left are operations performed at a client machine 208 and illustrated on the right are operations performed at a network-based marketplace 76. The method 600 commences at operation 602, with the client machine 208 communicating identity information to the network-based marketplace 76. For example, the identity information may include a user identifier in the form a user name and password that is associated by the network-based marketplace with a user identifier 458.

At operation 604, at the network-based marketplace 76, the receiving module 332 may receive the identity information and at operation 606 the receiving module 332 may register the identity information in association with a session that may be identified with a session identifier. For example, the session identifier may identify a session that is associated with the most recent login information received from the user.

At operation 608, at the client machine 208 and as part of the same session, the user may communicate a request for an analysis of all or a portion of the inventory associated with the seller.

At operation 610, at the network-based marketplace 76, the receiving module 332 may receive the request. At operation 612, the processing module 334 may identify all or part of the inventory associated with the seller on the network-based marketplace 76 based on the session identifier and the request. For example, the request may include a category identifier or some other identifier information that identifies all or a portion of the inventory associated with the seller. At operation 614, the processing module 334 may analyze the seller inventory in relation to inventory currently being offered for sale by other sellers. For example, the processing module 334 may identify the products being offered for sale by the seller on the network based marketplace 76 based on the inventory associated with the seller and utilize the associated product identifiers to identify items being offered for sale by other sellers on the network-based marketplace 76. According to one embodiment, the processing module 334 may iteratively pass product identifiers to the best match services modules 342 to identify item listings 426 currently being offered for sale by other sellers on the network-based marketplace. According to one embodiment the processing module 334 may invoke the trading service modules 340 and the finding service modules 342 with item identifiers that are utilized by the mentioned modules to retrieve further item information associated with the item listings 426. At operation, 616, the processing module 334 may invoke the POI module 336 to generate report information, according to one embodiment, in the form of Excel Spreadsheets®. At operation 618, the processing module 334 may communicate an interface to the client machine 208 that includes the report information. For example, the interface may include a user interface that includes the report information.

At operation 620, the client machine 208 receives and displays the user interface to the user.

According to another embodiment the receiving module 334 may be invoked via an application programming interface. For example, the receiving module 334 may receive the identity information and the request via an application programming interface rather than a web interface. According to another embodiment the request for the report may be queued for later processing and the report information may be viewed at the convenience of the user. According to another embodiment the report information may be emailed to the user or communicated to a location specified by the user. For example, the processing module 334 may be configured by the user to utilize the file transfer protocol (FTP) to communicate the report information to a location that is configured by the user. According to another embodiment the report may be queued in a job that executes periodically.

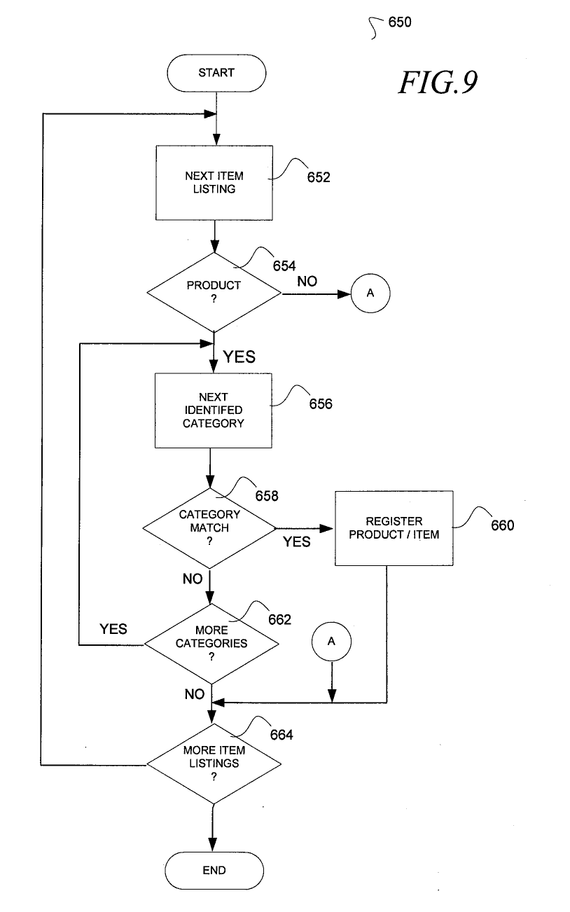

FIG. 9 is a flow chart illustrating a method 650, according to an embodiment, to identify seller inventory electronically being offered on for sale on a network-based marketplace 76. At operation, 652 the processing module 334 retrieves the next item listing 426 associated with the user. At decision operation 654, the processing module 334 identifies whether the item listing 426 describes an item that may be characterized as a standard product. For example, the processing module 334 may determine weather the item listing 426 includes a product identifier in the form of an ISBN, EAN or UPC. If the processing module 334 identifies the item listing 426 as describing an item that may be characterized as a product then the processing module 334 continues processing at decision operation 664. Otherwise the processing module 334 continues processing at operation 656. At operation 656, the processing module 334 retrieves the next category. That is, the operations 656, 658, 660 and 662 steps through a category data structure 500 starting with the category provide by the user provided by the user as described in operation 612 on FIG. 8. Specifically, the operations 656, 658, 660 and 662 begin with the user provide category and step through the categories that are included under the user provided category in the category data structure 500. At decision operation 658, the processing module 334 identifies whether the categories field 498 in the item listing 426 includes a category identifier that matches the current category. If the category matches, then the processing module 334 branches to operation 660. Otherwise the processing module 334 continues processing at decision operation 662. At operation 660, the processing module 334 registers the item/product as being included in the present analysis. At operation 662, the processing module 334 identifies whether more categories need to be processed. If more categories need to be processed then a branch is made to operation 656. Otherwise, processing continues at decision operation 664. At decision operation 664, the processing module 334 identifies whether more item listings 426 are to be processed. If more item listings 426 are to be processed then a branch is made to operation 652. Otherwise processing ends.

According to another embodiment the processing module 334 may execute in multiple threads/processes in parallel to process the item listings 426. Accordingly, each thread would include the processing module 334 processing an item listing 426 until all of the item listings 426 are completed.

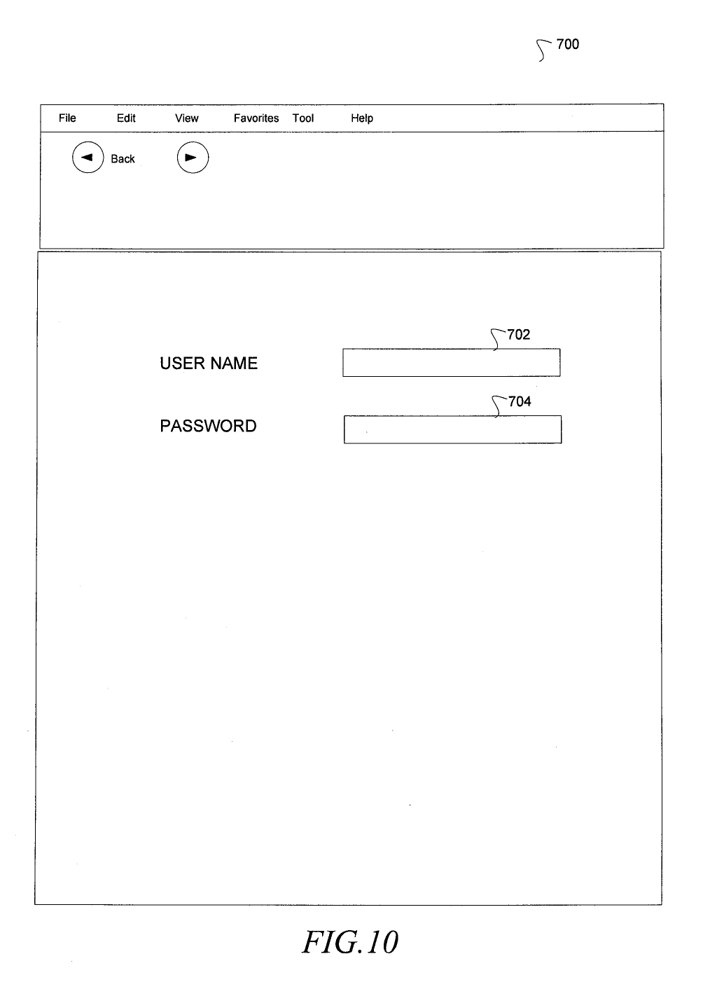

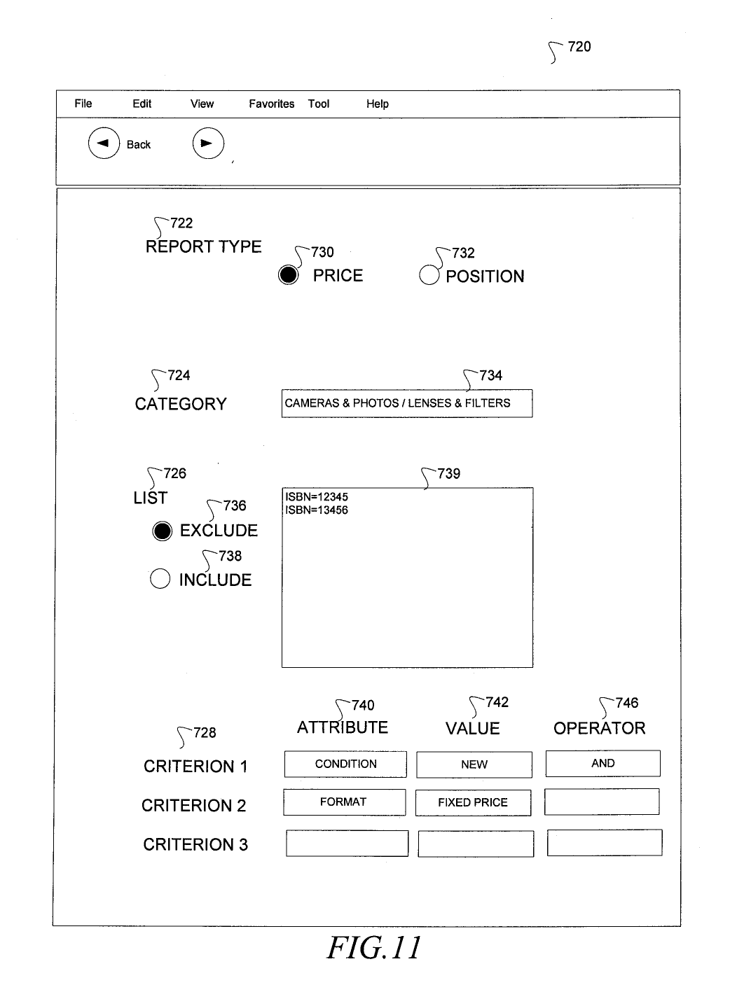

FIG. 10 is a diagram illustrating user interface 700, according to an embodiment. The user interface 700 may be utilized to receive identity information or other information that may be associated with identity information. The identity information may be utilized identify a user from other users on the network-based marketplace 76. The user interface 700 is shown to include input boxes 702 and 704 that are respectively utilized to receive a user name and a password. According to one embodiment the user name and the password may be utilized as identity information. According to another embodiment the user name and the password may be associated with identity information.

FIG. 11 is a diagram illustrating user interface 720, according to an embodiment. The user interface 720 may be utilized to receive a request for report information reporting for an analysis of items being offered for sale on the network-based marketplace 76. The user interface 720 may include user interface elements in the form of multiple request mechanisms. The multiple request mechanisms may include a report type 722, a category 724, a list 726, and criterion 728. The report type 722 request mechanism may be associated with a price report button 730 and a position report button 732. Selection of the price report button 730 or the position report button 732 without selection of another request mechanism including the category 724, list 726 or criterion 728 request mechanism results in the generation of report information that includes that all of the users item listings (e.g., inventory) that are currently being offered for sale on the network-based marketplace 76. Conversely, selection of at least one of the other request mechanisms including the category 724, the list 726 or the criterion 728 results in the generation of report information reporting on a sub-set of the users item listings (e.g., inventory) that are currently being offered for sale on the network-based marketplace 76. Turning to the report type 722, the price report button 730 may be selected to generate report information that is organized according to price. That is, the report information may include item listings in rows that are organized according to an ascending or descending price. The position report button 730 may be selected to generate report information that is organized according to position in search results. That is, the report information may include item listings 426 organized in rows according to an ascending or descending position/rank as registered in search results. The category 724 may be utilized to receive a category that is utilized to identify a sub-set of items that are included in the identified category and categories included under the identified category, as previously described. In one embodiment, the category 724 may be associated with an input box 734 that may be used to receive a category identify. In another embodiment, the input box 734 may be automatically updated with a category identifier based on navigation of a user to a particular category. The list 726 may be associated with an exclude button 736, an include button 738 and an input box 739. Selection of the include button 738 designates the input box 739 for reception of product numbers to be associated with item listings 426 that are to be included in the report information. Selection of the exclude button 738 designates the input box 739 for reception of product numbers to be associated with item listings 426 that are to be excluded from the report information. Multiple criterions 728 may be used to identify item listings 426 for inclusion in the report information. The criteria presented as multiple criterions 728 may be respectively associated with an attribute 740, a value 742 and an operator 746. The attribute 740 may identify a field in the item listing 426 and the value 742 may be used to receive a value associated with the attribute 740 that is compared with the field in the item listing 426. That is, a particular item listing 426 is included in the report information if the configured criterion evaluates TRUE. The operator 746 may be utilized to receive a Boolean operator (e.g., AND, OR, XOR) for evaluation of multiple criterion in combination.

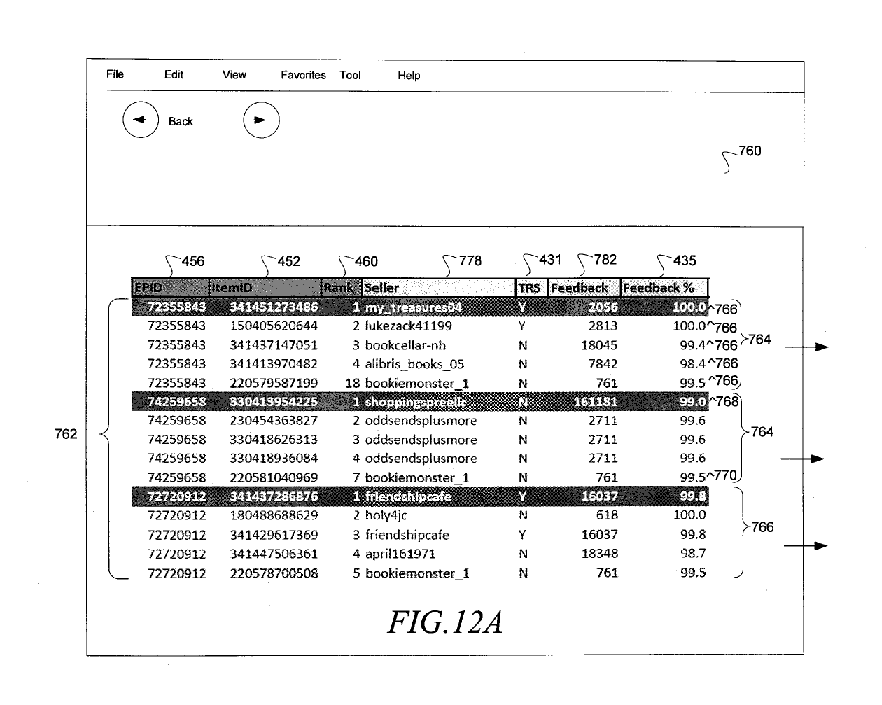

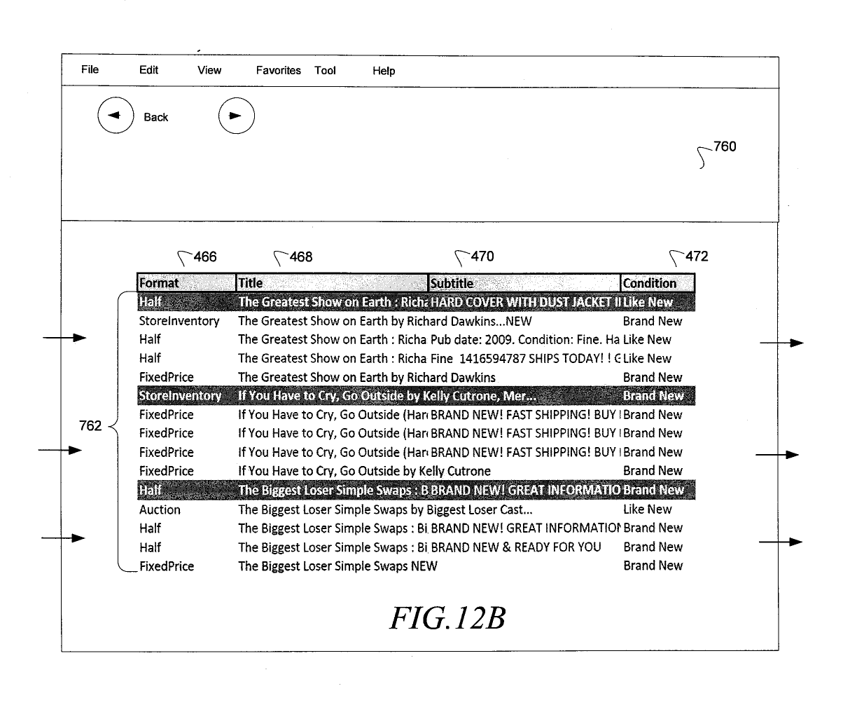

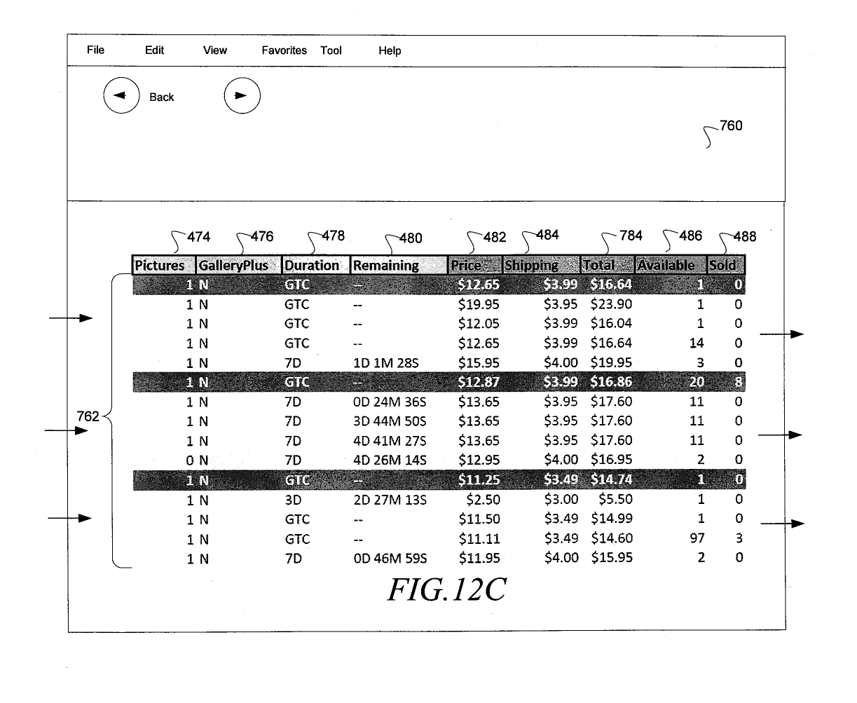

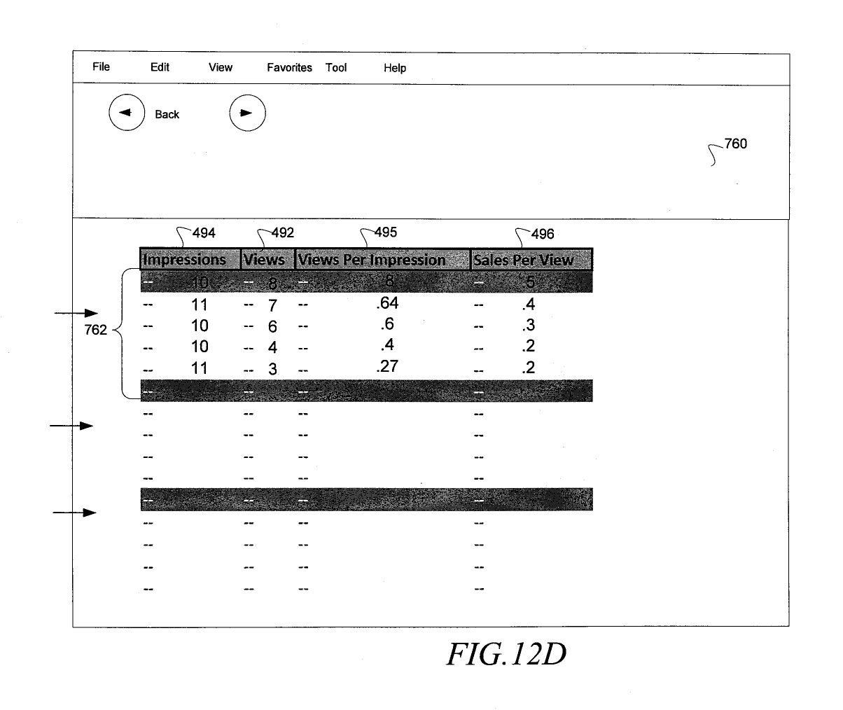

FIGS. 12A-12D are diagrams illustrating a user interface 760, according to an embodiment. The user interface 760 includes report information organized by row according to an ascending or descending position/rank as registered in search results. The report information 762 is shown to include product information sections 764 that respectively include rows 766 of item information 765 for a particular product that also include top rank information 768, 770. The rank information may include top rank information 768 and user rank information 770. The top rank information 768 is illustrated in the form of dark shading that identifies an item listing 426 with a top rank or position in search results. The top rank information typically highlights first row of each product information section 764. The user rank information 770 is illustrated in the form light shading that identifies an item listing 426 associated with the user that requested the analysis. Accordingly, the user rank information 770 and the top rank information 768 readily facilitate a quick comparison between the item listing 426 associated with the user and the item listing 426 with the top rank for each product information section 764 according to a position of the item listing 426 in search results. The report information 762 further includes columns of information that may respectively have a direct or indirect impact on the rank/position of the item listing 426 in search results. Other data is excluded. Accordingly, the user may interpret and infer the differences between item listings 426 as resulting in an optimal or suboptimal exposure of a particular item listing 426 in the search results.

FIG. 12A is a diagram illustrating a first part of user interface 760, according to an embodiment. The first part of user interface 760 is shown to include report information 762 that includes an extended product identifier 454, item identifiers 452, a top rated seller status 431, and a feedback percentage 784 all as previously described. The report information 762 further includes a rank 460 and a feedback count 782. The rank 460 or position indicates the rank of the item listing 426 as it appears in search results as previously described. The feedback count 782 is a count of the number of feedbacks left for the user.

FIG. 12B is a diagram illustrating a second part of user interface 760, according to an embodiment. The second part of user interface 760 is shown to include report information 762 that includes a format 466, a title 468, a subtitle 470 and a condition 472 all as previously described.

FIG. 12C is a diagram illustrating a third part of user interface 760, according to an embodiment. The third part of user interface 760 is shown to include report information 762 that includes a picture status 474, a gallery status 476, a duration 478, time remaining 480, a price 482, a shipping cost 484, and a sold count 488 all as previously described. The report information 762 further includes a total cost 784 which is a sum of the price 482 and the shipping 484 cost.

FIG. 12D is a diagram illustrating a fourth part of user interface 760, according to an embodiment. The fourth part of user interface 760 is shown to include report information 762 that includes impressions 494, views 492, view per impression 495, and sales per view 496 all as previously described.

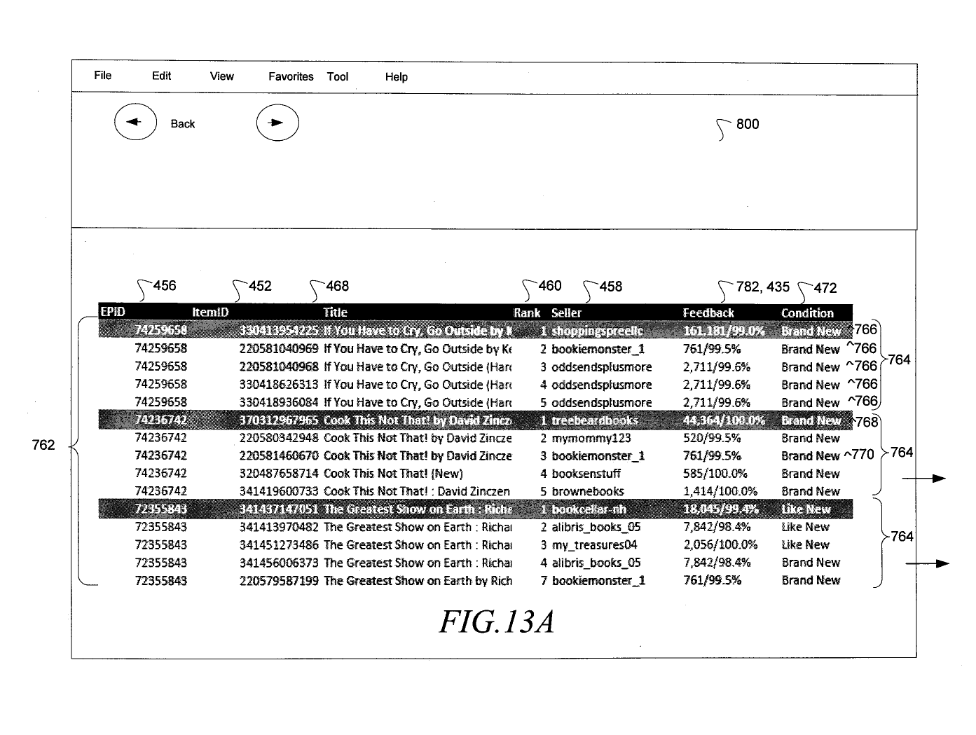

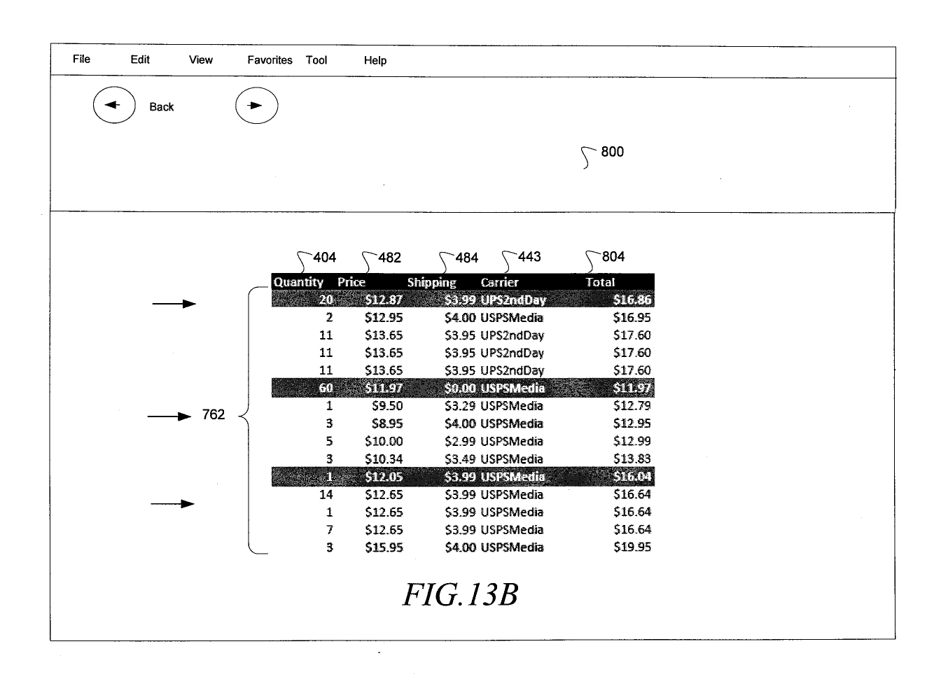

FIGS. 13A-13B are diagrams illustrating a user interface 800, according to an embodiment. The user interface 800 includes report information organized by row according to an ascending or descending price 482. The report information 762 is shown to include product information sections 764 that respectively include rows 766 of item information 765 for a particular product that also include rank information 768, 770. The rank information may include top rank information 768 and user rank information 770. The top rank information 768 is illustrated in the form of dark shading that identifies an item listing 426 with the lowest price 482 for the identified product. The top rank information typically highlights first row of each product information section 764. The user rank information 770 is illustrated in the form light shading that identifies an item listing 426 associated with the user that requested the analysis. Accordingly, the user rank information 770 and the top rank information 768 readily facilitate a quick comparison between the item listing 426 associated with the item listing 426 with the top rank for each product information section 764 according the price associated with item listings 426. The report information 762 further includes columns of information that may respectively have a direct or indirect impact on the total cost of an item listing 426 to a buyer. Other data is excluded. Accordingly, the user may interpret and infer the differences between item listings 426 as resulting in an optimal or suboptimal pricing for a particular item listing 426.

FIG. 13A is a diagram illustrating a first part of user interface 800, according to an embodiment. The first part of user interface 800 is shown to include report information 762 that includes an extended product identifier 454, an item identifiers 452, a title 468, a rank 460, a user name 429, a feedback count 782, feedback percentage 435, and a condition 472 all as previously described. The rank 460 or position indicates the rank of the item listing 426 with other item listings 426 according to price. For example, a rank of “1” may indicate the item listing that includes a price that is the lowest price for the identified product.

FIG. 13B is a diagram illustrating a second part of user interface 800, according to an embodiment. The second part of user interface 800 is shown to include report information 762 that includes a quantity 404, a price 482, a shipping cost 484 and a carrier 443 all as previously described. The report information 762 further includes a total 804 that is a monetary cost for purchasing and shipping the entire quantity 404 of items.

The above-described user interfaces are illustrated to include user interface elements. However, it will be appreciated by those skilled in the art that the user interfaces may also be embodied as a machine interface (e.g., Standard Generalized Markup Language (SGML)) including machine interface elements, an audio interface including audio interface elements, and a kinetic interface including kinetic interface elements.

In some embodiments, the methods described herein may be implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level and communicates the results of these logical/mathematical manipulations to the interface tier and/or to a backend, or storage, tier. These logical/mathematical manipulations may relate to certain business rules or processes that govern the software application as a whole. A third, storage, tier may be a persistent storage medium or non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer-to-peer, or so some other suitable configuration. Further, these three tiers may be distributed between multiple computer systems as various software components.

Some example embodiments may include the above illustrated tiers, and processes or operations that make them up, as being written as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique. These components may be linked to other components via various APIs and then compiled into one complete server, client, and/or peer software application. Further, these APIs may be able to communicate through various distributed programming protocols as distributed computing components.

Some example embodiments may include remote procedure calls being used to implement one or more of the above illustrated components across a distributed programming environment as distributed computing components. For example, an interface component (e.g., an interface tier) may reside on a first computer system that is remotely located from a second computer system containing a logic component (e.g., a logic tier). These first and second computer systems may be configured in a server-client, peer-to-peer, or some other suitable configuration. These various components may be written using the above illustrated object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language by using a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transport Control Protocol/Internet Protocol (TCP/IP) protocol stack model for defining the protocols used by a network to transmit data.

Some embodiments may utilize the OSI model or TCP/IP protocol stack model for defining the protocols used by a network to transmit data. In applying these models, a system of data transmission between a server and client, or between peer computer systems, is illustrated as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), WAN, or some other suitable network. In some cases, “Internet” refers to a network of networks. These networks may use a variety of protocols for the exchange of data, including the aforementioned TCP/IP, and additionally asynchronous transfer mode (ATM), system network architecture (SNA), SDI, or some other suitable protocol. These networks may be organized within a variety of topologies (e.g., a star topology) or structures.

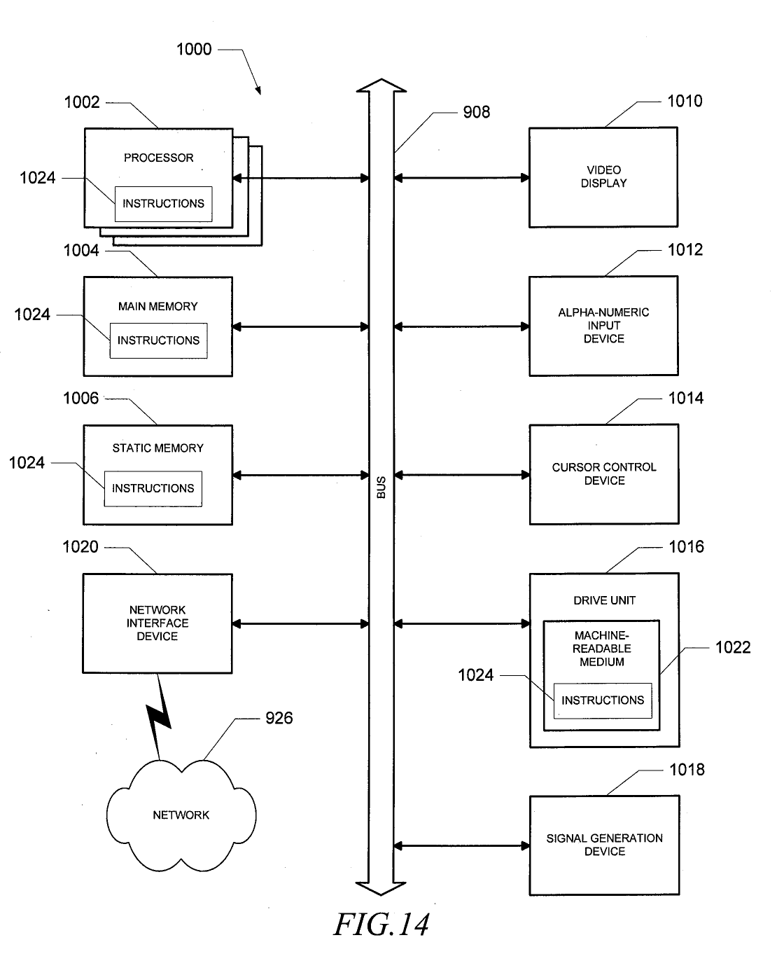

FIG. 14 shows a diagrammatic representation of a machine in the example form of a computer system 1000 within which a set of instructions may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a PDA, a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes one or more processors 1002 (e.g., a central processing unit (CPU), a graphics processing unit (GPU), or both), a main memory 1004 and a static memory 1006, which communicate with each other via a bus 1008. The computer system 1000 may further include a video display unit 1010 (e.g. a liquid crystal display (LCD) or a cathode ray tube (CRT)). The computer system 1000 also includes an input device 1012 (e.g., a keyboard), a cursor control device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions (e.g., software) 1024 embodying any one or more of the methodologies or functions described herein. The instructions 1024 may also reside, completely or at least partially, within the main memory 1004, the static memory 1006, and/or within the processor 1002 during execution thereof by the computer system 1000. The main memory 1004 and the processor 1002 also may constitute machine-readable media. The instructions 1024 may further be transmitted or received over a network 1026 via the network interface device 1020.

Software applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system (e.g., a standalone, client or server computer system) configured by an application may constitute a “module” that is configured and operates to perform certain operations as described herein. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any non-transitory medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical media and magnetic media. As noted, the software may be transmitted over a network using a transmission medium. The term “transmission medium” shall be taken to include any medium that is capable of storing, encoding or carrying instructions for transmission to and execution by the machine, and includes digital or analogue communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

Thus, systems and methods to analyze a seller inventory on a network-based marketplace 76 were described. While the present disclosure has been described in terms of several example embodiments, those of ordinary skill in the art will recognize that the present disclosure is not limited to the embodiments described, but may be practiced with modification and alteration within the spirit and scope of the appended claims. The description herein is thus to be regarded as illustrative instead of limiting.

What is claimed is:

1. A method comprising:
receiving identify information, over a network, from a client machine, the identify information identifying a seller that is registered to sell on a network-based marketplace;
receiving a request for an analysis of a first plurality of items being offered for sale by the seller on the network-based marketplace, the request including a category identifier that is utilized to identify the first plurality of items;
analyzing s first plurality of items listings being utilized to offer the first plurality of items for sale on the network-based marketplace to generate report information including item information describing the first plurality of items; and
communicating a user interface, over a network, to the client machine, the user interface including the report information.

2. The method of claim 1, wherein the request further includes a list of product identifiers that are utilized to exclude item information for a second plurality of items from the report information.

3. The method of claim 1, wherein the request includes a list of product identifiers that are utilized to identify the first plurality of items.

4. The method of claim 4, wherein the request includes a first criterion that includes an attribute and a value that are utilized to identify the plurality of items being offered for sale on the network-based marketplace.

5. The method of claim 1, wherein the request specifies the report information to not include an item that is offered for sale at a price that is identified as the lowest price item for a particular product.

6. The method of claim 1, wherein the plurality of items includes a first item, wherein the report information includes a plurality of product information sections, wherein the plurality of product information sections includes a first product information section that includes item information for a third plurality of items that includes the first item and item information for other items being offered for sale on the network-based marketplace by other sellers.

7. The method of claim 6, wherein the first item includes a product identifier that is utilized to identify the item as a product.

8. The method of claim 6 wherein the item information for each of the second plurality of items includes a price and wherein the item information for the second plurality of items is organized according to the price.

9. The method of claim 8 wherein the item information for each of the second plurality of items includes a rank for positioning the item in search results and wherein the item information for each of the second plurality of items is organized according to the rank.

10. A system comprising:
at least one processor;
a receiving module that is executable by a processor to receive identify information, over a network, from a client machine, the identify information to identify a seller that is registered to sell on a network-based marketplace; and
a processing module to receive a request for an analysis of a first plurality of items being offered for sale by the seller on the network-based marketplace, the request includes a category identifier that is utilized to identify the first plurality of items, the processing module to analyze a first plurality of items listings that are utilized to offer the first plurality of items for sale on the network-based marketplace, the processing module to generate report information including item information describing the first plurality of items and communicate a user interface, over a network, to the client machine, the user interface including the report information.

11. The method of claim 10, wherein the request further includes a list of product identifiers that are utilized to exclude item information for a second plurality of items from the report information.

12. The method of claim 10, wherein the request includes a list of product identifiers that are utilized to identify the first plurality of items.

13. The method of claim 13, wherein the request includes a first criterion that includes an attribute and a value that are utilized to identify the plurality of items being offered for sale on the network-based marketplace.

14. The method of claim 10, wherein the request specifies the report information to not include an item that is offered for sale at a price that is identified as the lowest price item for a particular product.

15. The method of claim 10, wherein the plurality of items includes a first item, wherein the report information includes a plurality of product information sections, wherein the plurality of product information sections includes a first product information section that includes item information for a third plurality of items that includes the first item and item information for other items being offered for sale on the network-based marketplace by other sellers.

16. The method of claim 15, wherein the first item includes a product identifier that is utilized to identify the item as a product.

17. The method of claim 15 wherein the item information for each of the second plurality of items includes a price and wherein the item information for the second plurality of items is organized according to the price.

18. The method of claim 17 wherein the item information for each of the second plurality of items includes a rank for positioning the item in search results and wherein the item information for each of the second plurality of items is organized according to the rank.

19. A non-transitory machine-readable medium storing instructions that, when executed by a machine, cause the machine to:
receive identify information, over a network, from a client machine, the identify information to identify a seller that is registered to sell on a network-based marketplace;
receive a request for an analysis of a first plurality of items that are offered for sale by the seller on the network-based marketplace, the request includes a category identifier that is utilized to identify the first plurality of items;
analyze a first plurality of items listings used to offer the first plurality of items for sale on the network-based marketplace to generate report information that includes item information that describes the first plurality of items; and
communicate a user interface, over a network, to the client machine, the user interface includes the report information.

20. A system comprising:
a first means that is executable by a processor to receive identify information, over a network, from a client machine, the identify information to identify a seller that is registered to sell on a network-based marketplace; and
a second means to receive a request for an analysis of a first plurality of items being offered for sale by the seller on the network-based marketplace, the request includes a category identifier that is utilized to identify the first plurality of items, the second means to analyze a first plurality of items listings that are utilized to offer the first plurality of items for sale on the network-based marketplace, the second means to generate report information including item information describing the first plurality of items and communicate a user interface, over a network, to the client machine, the user interface including the report information.
